(19) United States
(12) Patent Application Publication
(10) Pub. No.: US 2018/0302454 A1
(43) Pub. Date: Oct. 18, 2018

(54) AUDIO VISUAL INTEGRATION DEVICE

(71) Applicant: INTERLOCK CONCEPTS INC., Sandy, UT (US)

(72) Inventors: Bradley J. EHLERT, Sandy, UT (US); Shawn WHEELER, Sandy, UT (US)

(73) Assignee: INTERLOCK CONCEPTS INC., Sandy, UT (US)

(21) Appl. No.: 15/946,586

(22) Filed: Apr. 5, 2018

Related U.S. Application Data
(60) Provisional application No. 62/482,103, filed on Apr. 5, 2017.

(51) Int. Cl. H04L 29/06; H04N 21/2368; H04N 21/234

(52) U.S. Cl. CPC H04L 65/605; H04N 21/23424; H04N 21/2368

(57) ABSTRACT

The present disclosure generally relates to systems, devices, or methods for providing low-latency communication between content sources and output devices. An integration device may be configured to integrate input data streams from a plurality of sources, including legacy systems (e.g., intercom systems or telephone systems), and output a combined data stream to the relevant output devices. Rooms increasingly include a variety of multimedia devices such as televisions, speakers, projectors, individual computers, etc. In some cases, a room may have redundant output devices that are specialized for a particular system. For example, a room may have a speaker for a television, a speaker for an intercom system, a speaker for an audio system, or various combinations thereof. By managing multiple input data streams and multiple output data streams, the integration device may be configured to reduce the need for redundant hardware.

### RELATED APPLICATION

This application claims priority to U.S. Provisional Patent Application No. 62/482,103, filed 5 Apr. 2017, and entitled AUDIO VISUAL INTEGRATION DEVICE, pending, the disclosure of which is incorporated in its entirety by this reference.

### TECHNICAL FIELD

The present disclosure generally relates to audio visual integration devices, and more particularly relates to devices that integrate streams of data from multiple sources.

### BACKGROUND

Networked systems are increasingly important in modern society. Not all organizations are able to redesigning all of their systems for scratch so that all parts of their network system cooperate perfectly. Frequently, new systems are designed to be compatible with legacy systems that are already established.

In education settings, many schools have an existing intercom system that allows a classroom to communicate with other parts of the school. As classrooms increasingly incorporate multimedia access into teaching programs and into classroom equipment, opportunities exist for integrating classroom equipment with existing legacy systems of the classroom.

### SUMMARY

In one embodiment, an integration device or an integration system may include a first audio/visual endpoint coupled with a first content source, the first audio/visual endpoint configured to receive a first audio/visual data stream from the first content source, a second audio/visual endpoint coupled with a second content source, the second audio/visual endpoint configured to receive a second audio/visual data stream from the second content source, an integrator coupled with the first audio/visual endpoint and the second audio/visual endpoint, the integrator configured to merge the first audio/visual data stream and the second audio/visual data stream into a combined data stream, and a third audio/visual endpoint coupled with the integrator, the third audio/visual endpoint configured to output the combined data stream to a remote output device.

In some examples of the integration device or integration system described above, the integrator may be configured to time-stamp the first audio/visual data stream as it may be received and time-stamp the second audio/visual data stream as it may be received.

In some examples of the integration device or integration system described above, the integrator may be configured to correlate a timing of the first audio/visual data stream and a timing of the second audio/visual data stream based at least in part on the time-stamping the first audio/visual data stream and the second audio/visual data stream.

In some examples of the integration device or integration system described above, the first audio/visual data stream comprises audio data and the second audio/visual data stream comprises visual data.

In some examples of the integration device or integration system described above, the first content source comprises a microphone configured to output a signal representative of a human voice, wherein the integrator may be configured to merge the audio data with the visual data to generate a synchronized multimedia presentation.

In some examples of the integration device or integration system described above, the first content source comprises a telephone, wherein the integrator may be configured to merge the audio data with the visual data to generate a synchronized recording of the audio data and the visual data.

In some examples of the integration device or integration system described above, the telephone may be part of an emergency calling system configured to receive emergency calls.

In some examples of the integration device or integration system described above, the second content source a visual output of a computer, wherein the integrator may be configured to mitigate a mismatch between the audio data of the telephone and the visual output of the computer.

In some examples of the integration device or integration system described above, the first audio/visual data stream comprises first visual data and the second audio/visual data stream comprises second visual data.

In some examples of the integration device or integration system described above, the integrator may be configured to overlay the first visual data over the second visual data.

In some examples of the integration device or integration system described above, the first visual data may be an advertisement and the second visual data may be television data.

In some examples of the integration device or integration system described above, the integrator may be configured to determine a priority of a communication in the first audio/visual data stream and interrupt the combined data stream based at least in part on determining the priority of the communication.

In some examples of the integration device or integration system m described above, the first audio/visual endpoint may be an intercom endpoint coupled with a local intercom system, the intercom endpoint configured to receive an audio data stream from a remote intercom endpoint of the local intercom system different than the intercom endpoint.

In some examples of the integration device or integration system described above, the first audio/visual endpoint comprises a high-definition multimedia interface (HDMI) port.

In some examples of the integration device or integration system described above, an infrared receiver configured to detect signals using an infrared frequency spectrum band.

In some examples of the integration device or integration system described above, an ultrasonic transceiver configured to generate or detect signals using an ultrasonic frequency spectrum band.

In some examples of the integration device or integration system described above, a component audio video (CAV) port configured to be coupled with an electronic marquee sign, wherein the integrator may be configured to generate an output for the electronic marquee sign based at least in part on the first audio/visual data stream or the second audio/visual data stream.

In one embodiment, an integration system may include a first integration device in a first room of a building, the first integration device including a first audio/visual endpoint configured to receive a first audio/visual data stream and a second audio/visual endpoint configured to receive a second audio/visual data stream, the first integration device configured to merge the first audio/visual data stream and the second audio/visual data stream to form a third audio/visual data stream, and a second integration device in a second room of the building, the second integration device coupled with the first integration device via a communication link and configured to receive the third audio/visual data stream from the first integration device, the second integration device including a third audio/visual endpoint configured to receive a fourth audio/visual data stream from a content source, the second integration configured to merge the third audio/visual data stream received from the first integration device and the fourth audio/visual data stream to form a fifth audio/visual data stream.

In some examples of the system described above, the second integration device may be configured to transmit the fifth audio/visual data stream to the first integration device.

In some examples of the system described above, the first integration device outputs the fifth audio/visual data stream to a first output device and the second integration device outputs the fifth audio/visual data stream to a second output device simultaneously to reduce offsets in a presentation of audio/visual content between the first room and the second room.

In some examples of the system described above, the first integration device and the second integration device may be configured to time-stamp audio/visual data streams as the audio/visual data streams may be received, wherein merging two different audio/visual data streams and outputting the audio/visual data streams may be based at least in part on the time-stamping.

In some examples of the system described above, the first audio/visual data stream comprises video data. In some examples of the system described above, the second audio/visual data stream comprises first audio data of a voice of a user in the first room received from a first microphone. In some examples of the system described above, the fourth audio/visual data stream comprises second audio data for a voice of a user in the second room received from a second microphone. In some examples of the system described above, the fifth audio/visual data stream comprises the video data, the first audio data from the first room, and the second audio data from the second room.

A method for operating an integration device is described. The method may include receiving a first audio/visual data stream from a first content source, time-stamping the first audio/visual data stream as it is received, buffering the time-stamped first audio/visual data stream, receiving a second audio/visual data stream from a second content source, time-stamping the second audio/visual data stream as it is received, buffering the time-stamped second audio/visual data stream, merging the buffered first audio/visual data stream and the buffered second audio/visual data stream based at least in part on the time-stamping to form a combined data stream, and outputting the combined data stream to a remote output device.

An apparatus is described. The apparatus may include means for receiving a first audio/visual data stream from a first content source, means for time-stamping the first audio/visual data stream as it is received, means for buffering the time-stamped first audio/visual data stream, means for receiving a second audio/visual data stream from a second content source, means for time-stamping the second audio/visual data stream as it is received, means for buffering the time-stamped second audio/visual data stream, means for merging the buffered first audio/visual data stream and the buffered second audio/visual data stream based at least in part on the time-stamping to form a combined data stream, and means for outputting the combined data stream to a remote output device.

Another apparatus is described. The apparatus may include a processor, memory in electronic communication with the processor, and instructions stored in the memory. The instructions may be operable to cause the processor to receive a first audio/visual data stream from a first content source, time-stamp the first audio/visual data stream as it is received, buffer the time-stamped first audio/visual data stream, receive a second audio/visual data stream from a second content source, time-stamp the second audio/visual data stream as it is received, buffer the time-stamped second audio/visual data stream, merge the buffered first audio/visual data stream and the buffered second audio/visual data stream based at least in part on the time-stamping to form a combined data stream, and output the combined data stream to a remote output device.

A non-transitory computer-readable medium for operating an integration device is described. The non-transitory computer-readable medium may include instructions operable to cause a processor to receive a first audio/visual data stream from a first content source, time-stamp the first audio/visual data stream as it is received, buffer the time-stamped first audio/visual data stream, receive a second audio/visual data stream from a second content source, time-stamp the second audio/visual data stream as it is received, buffer the time-stamped second audio/visual data stream, merge the buffered first audio/visual data stream and the buffered second audio/visual data stream based at least in part on the time-stamping to form a combined data stream, and output the combined data stream to a remote output device.

Some examples of the method, apparatus, and non-transitory computer-readable medium described above may further include processes, features, means, or instructions for correlating a timing of the first audio/visual data stream with a timing of the second audio/visual data stream based at least in part on the time-stamping, wherein merging the buffered first audio/visual data stream and the buffered second audio/visual data stream may be based at least in part on correlating the timings.

Some examples of the method, apparatus, and non-transitory computer-readable medium described above may further include processes, features, means, or instructions for determining a priority of a communication in the first audio/visual data stream. Some examples of the method, apparatus, and non-transitory computer-readable medium described above may further include processes, features, means, or instructions for interrupting the second audio/visual data stream to output the first audio/visual data stream based at least in part on determining the priority of the communication.

Some examples of the method, apparatus, and non-transitory computer-readable medium described above may further include processes, features, means, or instructions for overlaying a visual portion of the first audio/visual data stream over a visual portion of the second audio/visual data stream to generate a composite image.

Some examples of the method, apparatus, and non-transitory computer-readable medium described above may further include processes, features, means, or instructions for generating data for an electronic marquee sign based at least in part on the first audio/visual data stream or the second audio/visual data stream.

Some examples of the method, apparatus, and non-transitory computer-readable medium described above may further include processes, features, means, or instructions for receiving audio data from a remote intercom endpoint of a local intercom system. Some examples of the method, apparatus, and non-transitory computer-readable medium described above may further include processes, features, means, or instructions for interrupting the combined data stream and outputting the audio data received from the remote intercom endpoint.

Some examples of the method, apparatus, and non-transitory computer-readable medium described above may further include processes, features, means, or instructions for transmitting the combined data stream to the first content source based at least in part on the first content source being an integration device, wherein the first content source may be configured to output the combined data stream to a second output device different than the remote output device.

Some examples of the method, apparatus, and non-transitory computer-readable medium described above may further include processes, features, means, or instructions for outputting the combined data stream at the same time with the first content source outputs the combined data stream based at least in part on transmitting the combined data stream to the first content source.

In some examples of the method, apparatus, and non-transitory computer-readable medium described above, the first content source may be a telephone and the second content source may be a visual output of a computer.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 illustrates a perspective view of an integration device.

FIG. 2 illustrates a back elevation view of the integration device of FIG. 1.

FIG. 3 illustrates a block diagram illustrating simplified components of the integration device of FIG. 1.

FIG. 4 illustrates a block diagram illustrating the integration device of FIG. 1 incorporated into a classroom setting.

FIG. 5 illustrates a block diagram illustrating the integration device of FIG. 1 incorporated into a an emergency response setting.

FIG. 6 illustrates a block diagram illustrating the integration device of FIG. 1 incorporated into a public viewing setting.

FIG. 7 illustrates an example of a method performed by the integration device of FIG. 1.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present disclosure generally relates to an integration device for providing low-latency communication between content sources and output devices. The integration device may be configured to integrate input data streams from a plurality of sources, including legacy systems (e.g., intercom systems or telephone systems), and output a combined data stream to the relevant output devices.

For example, in a classroom setting, the integration device may be configured to connect a plurality of input sources with a plurality of multimedia devices and provide a hub for centralized connections and control. Classrooms increasingly include a variety of multimedia devices such as televisions, speakers, projectors, individual computers, etc. In some cases, the classrooms may have redundant output devices that are specialized for a particular system. For example, a classroom may have a speaker for a television, a speaker for an intercom system, a speaker for an audio system, or various combinations thereof. The integration device may be configured to remove some of the redundancies in the classroom.

The integration device may also provide a low-latency connection between content sources and output devices. Some integration devices introduce latency into multimedia presentation through their processing of input data streams. For example, a teacher may use a computer and a television to present a video to the students. An integration device may cause a time delay between the output of the computer and the output of television. Such a time delay may cause problems with the presentation. In other examples, time delays in multi-classroom presentations may cause audible echoes or difficulty communicating between classrooms. As such, an integration device that provides low-latency processing may mitigate some of these issues.

The present disclosure provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

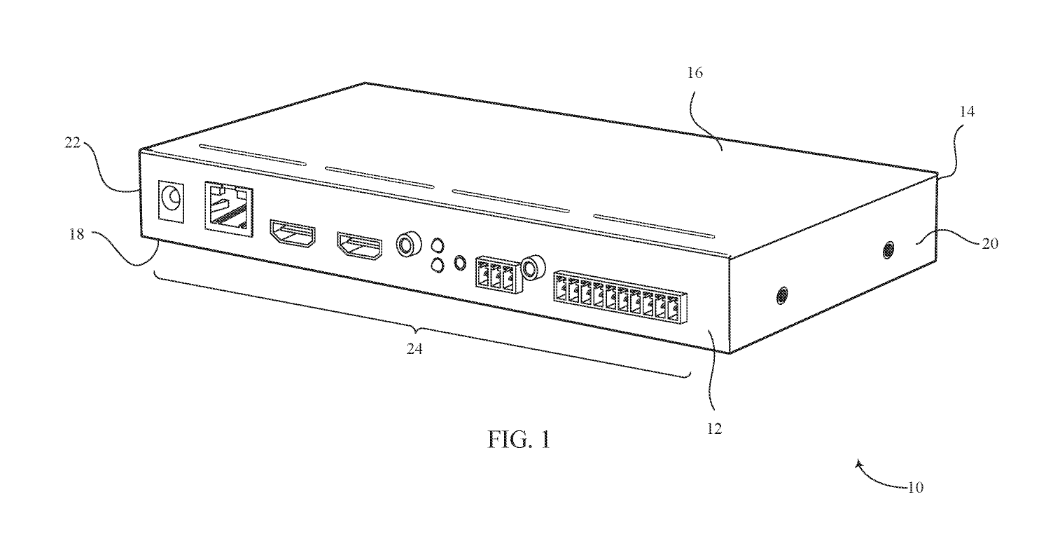

Referring now to the figures in detail, FIG. 1 shows an integration device 10 configured to provide low-latency processing of data streams and integrate inputs from multiple systems. The integration device 10 includes a back wall 12, a front wall 14 positioned opposite the back wall 12, a top wall 16, a bottom wall 18 positioned opposite the top wall 16, and two side walls 20, 22 positioned opposite one another.

The integration device 10 may include a plurality of ports 24 positioned in the back wall 12. The plurality of ports 24 may be configured to receive wired data connections of various types. In some examples, the plurality of ports 24 may be examples of female sockets for their respective port types. The plurality of ports 24 may include a power port, a high-definition multimedia interface (HDMI) port, an audio port, a serial port, a component audio/video port, multi-pin ports, other types of ports, or combinations thereof. In some examples, the integration device 10 may include circuity to communicate via one of a plurality of wireless radio access technologies (RATs). For example, the integration device 10 may include antennas and other circuitry to communicate using cellular RATs (e.g., 3G, 4G, 5G), Wi-Fi (e.g., RATs associated with IEEE 802.11 standards), Bluetooth, or combinations thereof.

The integration device 10 may also include an infrared (IR) receiver (not shown). The IR receiver may be configured to detect signals transmitted using the infrared frequency spectrum band. The IR receiver may be positioned adjacent to the front wall 14 of the integration device 10. In some examples, the front wall 14 may include an aperture (not shown) through which the IR receiver may protrude.

In some examples, the integration device 10 may include an ultrasonic transceiver (not shown). The ultrasonic transceiver may be configured to generate or detect signals using the ultrasonic frequency spectrum band. The ultrasonic frequency spectrum band may refer to frequencies just above the hearing range of most humans. In some examples, the ultrasonic frequency spectrum may be in the range between 20 kHz and 25 kHz. Many modern electronic devices include microphones and speakers that can communicate in the ultrasonic range to ensure that performance in the typical human hearing range is optimal. The integration device 10 may be configured to communicate with other devices (e.g., computers, smartphones, tablets, etc.) using ultrasonic signals.

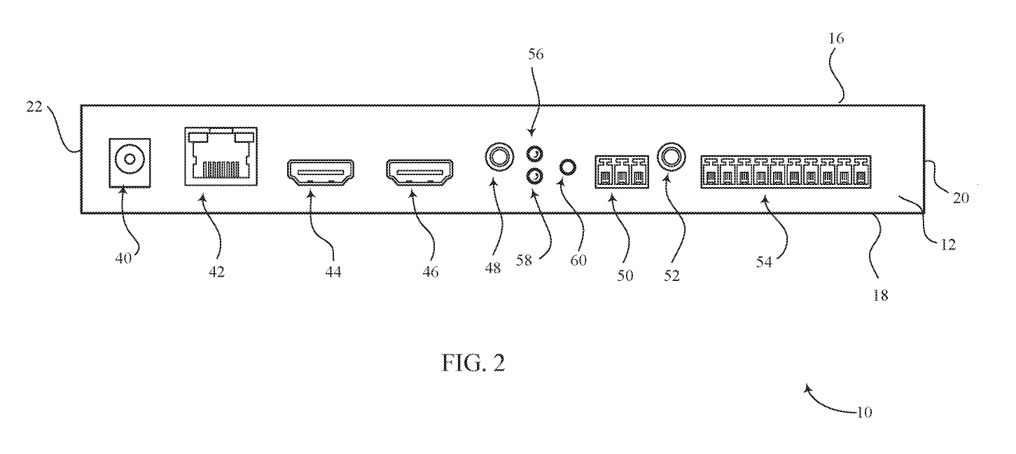

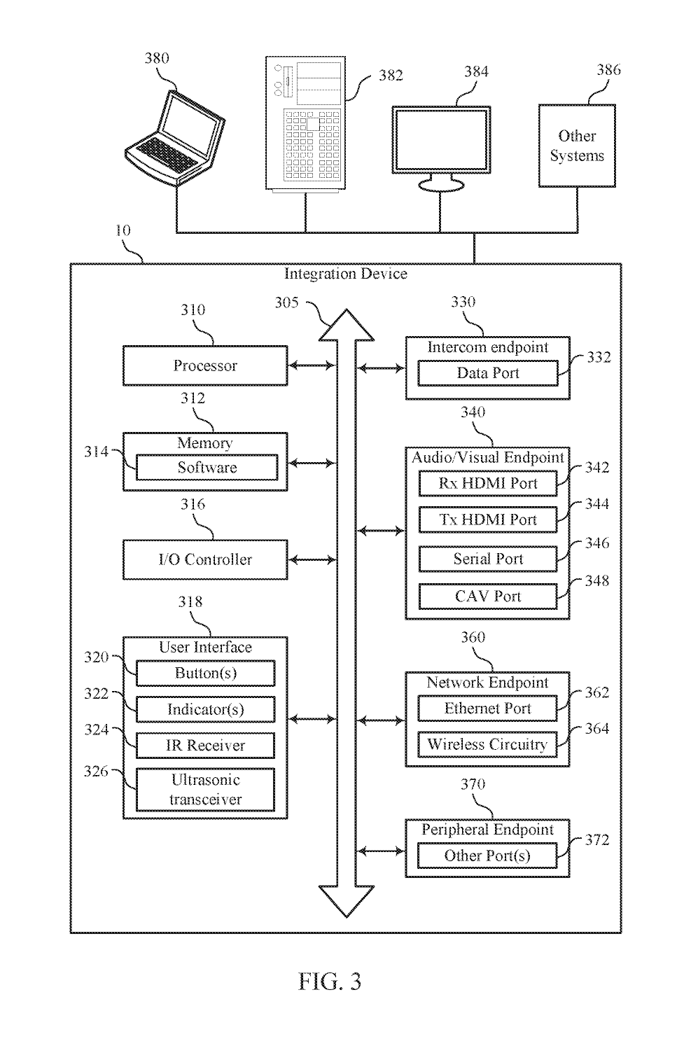

FIG. 2 shows a back elevation view of the integration device 10. The ports of the integration device 10 may include a power port 40, an Ethernet port 42, a first HDMI port 44, a second HDMI port 46, an audio port 48, a serial port 50, a component audio video port 52, and a multi-pin port 54. In addition, the integration device 10 may include a number of input/output devices. For example, the integration device 10 may include a first indicator 56, a second indicator 58, and button 60. The functions of each of these components of the integration device 10 are described with more detail in FIG. 3.

The power port 40 may be adjacent to the one of the sidewalls 22. The Ethernet port 42 may be positioned next to the power port 40 opposite the sidewall 22. The two HDMI ports 44, 46 may be positioned next to one other. The first HDMI port 44 may be configured to receive data streams and the second HDMI port 46 may be configured to output data streams. Using the two HDMI ports 44, 46, the integration device 10 may be installed in-line between a content source (e.g., computer) and an output device (e.g., TV or projector). The audio port 48 may be configured to receive data streams from a legacy audio system (e.g., an intercom system in a school, a telephone system in an emergency response situation). The integration device may be configured to merge a first data stream received at the first HDMI port 44 and a second data stream received at the audio port 48 and output a combined data stream from the second HDMI port 46. The second HDMI port 46 may be positioned between the first HDMI port 44 and the audio port 48.

The I/O devices 56, 58, 60 may be positioned between ports 40, 42, 44, 46, 48 and ports 50, 52, 54. The indicators 56, 58 may be examples of light emitting diodes (LEDs). The first indicator 56 may be a red LED configured to indicate when powered that the integration device 10 is not functioning properly. The second indicator 58 may be a green LED configured to indicate when powered that the integration device 10 is functioning properly. The button 60 may be a reset button configured to reset the integration device 10 based on the button being actuated.

The multi-pin port 54 may be positioned adjacent to one of the sidewalls 20. The CAV port 52 may be positioned adjacent to the multi-pin port 54 opposite the sidewall 20. The serial port 50 may be positioned between the CAV port 52 and the button 60.

FIG. 3 is a block diagram illustrating simplified components of the integration device 10. The integration device 10 may include components for bi-directional voice and data communications including components for transmitting and receiving communications, including processor 310, memory 312, software 314, I/O controller 316, user interface 318, an intercom endpoint 330, and audio/visual endpoint 340, a network endpoint 360, and a peripheral endpoint 370. These components may be in electronic communication via one or more busses (e.g., bus 305).

In some cases, integration device 10 may communicate with a computing device 380, a remote storage device, a remote server 382, an audio/visual output device 384 (e.g., television, projector system, or monitor), and/or other system 386 (e.g., intercom system, audio system, I/O devices, telephone system). For example, one or more elements of the integration device 10 may provide a direct connection to a remote server 382 via one or more of the endpoints described herein. In some embodiments, one element of the integration device 10 (e.g., one or more antennas, transceivers, etc.) may provide a connection using wireless techniques, including digital cellular telephone connection, Cellular Digital Packet Data (CDPD) connection, digital satellite data connection, and/or another connection.

Many other devices and/or subsystems may be connected to one or may be included as one or more elements of the device 10 (e.g., cameras, wireless remote, wall mounted user interface, battery, lighting system, and so on). In some embodiments, all of the elements shown in FIG. 3 need not be present to practice the present systems and methods. The devices and subsystems may also be interconnected in different ways from that shown in FIG. 3. In some embodiments, an aspect of the operations of the device 10 may be readily known in the art and are not discussed in detail in this disclosure.

The signals associated with the device 10 may include wireless communication signals such as radio frequency, electromagnetics, LAN, WAN, VPN, wireless network (using 802.11, for example), 345 MHz, Z-WAVE®, cellular network (using 3G and/or Long Term Evolution (LTE), for example), and/or other signals. The RAT of the device 10 may be related to, but are not limited to, wireless wide area network (WWAN) (GSM, CDMA, and WCDMA), wireless local area network (WLAN) (including BLUETOOTH® and Wi-Fi), WiMAX, antennas for mobile communications, antennas for Wireless Personal Area Network (WPAN) applications (including radio frequency identification devices (RFID) and UWB). In some embodiments, one or more sensors (e.g., IR, ultrasonic, motion, light, sound) may connect to some element of the device 10 via a network using the one or more wired and/or wireless connections.

Processor 310 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). Processor 310 may be configured to execute computer-readable instructions stored in a memory to perform various functions. In some examples, the processor 310 may be referred to as an integrator.

Memory 312 may include RAM and ROM. The memory 312 may store computer-readable, computer-executable software 314 including instructions that, when executed, cause the processor to perform various functions described herein. In some cases, the memory 312 may store the software 314 associated with the device 10. In some cases, the memory 312 may contain, among other things, a basic input/output system (BIOS) which may control basic hardware and/or software operation such as the interaction with peripheral components or devices.

Software 314 may include code to implement aspects of the present disclosure, including code to support the device 10. Software 314 may be stored in a non-transitory computer-readable medium such as system memory or other memory. In some cases, the software 314 may not be directly executable by the processor but may cause a computer (e.g., when compiled and executed) to perform functions described herein.

I/O controller 316 may manage input and output signals for device 10. I/O controller 316 may also manage peripherals not integrated into device 10. In some cases, I/O controller 316 may represent a physical connection or port to an external peripheral. In some cases, I/O controller 316 may utilize an operating system such as iOS®, ANDROID®, MS-DOS®, MS-WINDOWS®, OS/2®, UNIX®, LINUX®, or another known operating system. In other cases, I/O controller 316 may represent or interact with a modem, a keyboard, a mouse, a touchscreen, or a similar device. In some cases, I/O controller 316 may be implemented as part of a processor. In some cases, a user may interact with the device 10 via I/O controller 316 or via hardware components controlled by I/O controller 316.

User interface 318 may enable a user to interact with the device 10. The user interface 318 may include one or more buttons 320, one or more indicator(s), an IR receiver 324, an ultrasonic transceiver 326, other user I/O devices, or combinations thereof. In some examples, the user interface 318 may include speakers, display devices (e.g., TV, monitor, projector), touchscreens, keyboards, mice, buttons, microphone, etc.

The button 320 may be configured to perform any number of functions. In some examples, the button 320 may be an example of reset button configured to reset/restart the integration device 10 based on being actuated. The button 320 may be an example of the button 60 described with reference to FIGS. 1 and 2. In other examples, the integration device 10 may include a plurality of buttons, such as a keypad, keyboard, or other collection of buttons. The button 320 may be configured to receive commands from a user.

The indicator(s) 322 may be configured to output information to the user. In some examples, the indicators 322 include a first indicator and a second indicator. The indicator 322 may be an example of a LED light. The indicator 322 may be an example of the indicators 56, 58 described with reference to FIGS. 1 and 2. In some examples, the indicators 322 may be any output device that is observable by a user. For example, the indicators 322 may be screens, displays, monitors, touchscreens, speakers, tactile devices, or combinations thereof.

The IR receiver 324 may be configured to detect signals transmitted in the IR frequency spectrum band. IR transmitter may be incorporated into another device, such as a remote. The IR receiver 324 may be configured to receive IR signals and decode information included in the IR signals. The IR receiver 324 may be an example of the IR receiver described with reference to FIG. 1.

The ultrasonic transceiver 326 may be configured to communicate using signals transmitted in the ultrasonic frequency spectrum band. Ultrasonic signals may be communicated using frequencies just outside of the range of normal human hearing. The integration device 10 may include an ultrasonic transmitter to communicate data with other computing devices in the vicinity of the integration device 10. Many microphones of computing devices (e.g., smartphones, cell phones, computing devices) are capable of detecting ultrasonic signals. In some examples, the integration device 10 may transmit a message via ultrasonic signal. The integration device 10 may include an ultrasonic receiver to receive data from other computing devices in the vicinity of the integration device 10. The ultrasonic transceiver 326 may be an example of the ultrasonic receiver described with reference to FIG. 1.

The intercom endpoint 330 may be a terminal node of an intercom system that is configured to communicate data with other endpoints and control points of the intercom system. The intercom endpoint 330 may be configured to interface with legacy intercom systems of a building. The intercom endpoint 330 of the integration device 10 may include a data port 332. The data port 332 may be configured to establish a wired connection with the intercom system. The data port 332 may be an example of the audio port 48 described with reference to FIG. 2. The data port 332 may be an example of an AUX port. The data port 332 may be an example of an R/L component audio port. The data port 332 may be an example of a component audio video port. In some examples, the data port 332 may include a component audio to HDMI converter.

As used herein, the term endpoint may refer to circuitry used to communicate data with an associated system. An endpoint may include ports and associated components to decode and encode information communicated through the port. As used herein, the term port may refer to any electrical connection. A port may sometimes be referred to as a connector. A port may include a male connector (e.g., protrusion) or a female connector (e.g., socket or receptacle). In some examples, the ports of the integration device 10 are female connectors sized to receive corresponding male connectors associated with cables or other electronic components.

The audio/visual endpoint 340 may be a terminal node of an audio/visual system that is configured to communicate data with both content sources (e.g., computers, smartphones) and output devices (e.g., monitors, speakers). The audio/visual endpoint 340 may include a plurality of ports and associated circuitry to process data streams communicated through those ports. The audio/visual endpoint 340 may include a input HDMI port 342, an output HDMI port 344, a serial port 346, a component audio video (CAV) port 348, other ports, or combinations thereof.

The audio/visual endpoint 340 may be dynamically changeable to include different combinations of ports and circuitry depending on the functions being performed. For example, the audio/visual endpoint 340 may be configured such that the device 10 may serve as an in-line device between a content source (e.g., computing device 380) and a display device (e.g., monitor 384). In such examples, the audio/visual endpoint 340 may include the two HDMI ports 342, 344. In other examples, the display device may include a projector system and/or a separate speaker system. In such instances, the audio/visual endpoint 340 may include the serial port 346 (to control one or more of the third party device) and/or the multi-pin connector to communicate data with the speakers.

The HDMI ports 342, 344 may be examples of the ports 44, 46 described with reference to FIG. 2. The serial port 346 may be configured to communicate information between the integration device 10 and any number of devices (e.g., projectors). Some devices are configured to receive instructions and other data in addition to receive streams of audio data and/or visual data. The serial port 346 may be configured to communicate these other types of information, data, and/or commands. The serial port 346 may be an example of an RS-232 port, in some cases. The serial port 346 may be an example of the serial port 50 described with reference to FIG. 2. The CAV port 348 may be configured to communicate streams of data (input or output) with various output devices (e.g., displays or speakers). In some examples, the CAV port 348 is a CAV output. The CAV port 348 may be configured to communicate commands with an electronic marquee sign or other information display device. The CAV port 348 may be an example of the CAV port 52 described with reference to FIG. 2.

The network endpoint 360 may be configured communicate information using one or more different types of networks. For example, the network endpoint 360 may be configured to communicate data using an Ethernet network. In other examples, the network endpoint 360 may be configured to communicate data using a wireless network (e.g., Wi-Fi, cellular networks, Bluetooth, WLANs, etc.). The network endpoint 360 may include an Ethernet port 362 and wireless circuitry 364.

The Ethernet port 362 may be configured to communicate data over an Ethernet network. In some examples, the Ethernet port 362 may be have a Power over Ethernet (POE) capability such that electric power is received from the Ethernet network. As such, portions (or all) of the device 10 may be powered using POE. The Ethernet port 362 may be an example of the Ethernet port 42 described with reference to FIG. 2.

The wireless circuitry 364 may include antennas and other electrical components configured to communicate data over a wireless network. The wireless circuitry 364 may be integrated into the device 10. In some examples, the device 10 may include an internal port (e.g., USB port) to couple to self-contained wireless transceivers and components (e.g., Wi-Fi stick).

The network endpoint 360 may communicate bi-directionally, via one or more antennas, wired, or wireless links as described above. For example, the network endpoint 360 may represent a wireless transceiver and may communicate bi-directionally with another wireless transceiver. The network endpoint 360 may also include a modem to modulate the packets and provide the modulated packets to the antennas for transmission, and to demodulate packets received from the antennas. The network endpoint 360 may communicate bi-directionally with the computing device 380, the server 382, the output device 384, the other systems 386, or combinations thereof. The network endpoint 360 may include a USB port, wireless network circuitry, other network components or ports, or combinations thereof. The wireless circuitry 364 may be configured to establish a wireless communication link via a wireless network. The other network components or ports may be any other type of communication circuitry to establish communications (either wired or wireless) between the device 10. For example, the other network components may include components related to VGA, DVI, HDMI, IDE, SATA, eSATA, FireWire, Ethernet, PS/2, a serial connections, a RS-232 serial connection, a DB-25 serial connection, a DE-9 serial connection, an S-Video connection, a DIN connection, Wi-Fi, LTE, 3G, Bluetooth, Bluetooth Low Energy, WLAN, WiGig, or combinations thereof.

The peripheral endpoint 370 is configured to communicate data with a variety of other systems. The peripheral endpoint 370 may include other ports 372. The peripheral endpoint 370 may be configured to communicate with telephone systems, emergency systems, power systems, speaker systems, other I/O devices, output devices, or combinations thereof.

The other ports may include power ports, multi-pin ports, serial ports, CAV ports, or combinations thereof. For example, a multi-pin port may be configured to include ten pins. The multi-pin port may be configured to communicate with speakers (two pins), to communicate with amplifiers (two pins), to communicate with microphones or other audio input devices (two pins), to communicate with other digital devices such as input buttons/actuators or indicators, or combinations thereof. The multi-pin port may be an example of the multi-pin port 54 described with reference to FIG. 2. In some examples, the multi-pin port may be 10 pin phoenix port. The multi-pin port may be coupled to speaker out signals, microphone in signals, and other inputs and outputs.

The integration device 10 may be configured to communicate data with a variety of different systems. For example, the integration device 10 may be communicate with a computing device 380, a server 382, an output device 384, or other systems 386 via one of the endpoints or ports described herein.

In some examples, the computing device 380 may be considered a content source. As used herein, a content source may refer to any device or system that provides multimedia data (e.g., audio or visual) to the device 10. The computing device 380 (e.g., content source) may be coupled to the device 10 via the input HDMI port 342. The computing device 380 may be an example of any content source. For example, the computing device 380 may be a personal computer, a server, a cable box, a satellite box, an antenna, a smartphone, a hand-held computing device, tablet, etc.

In some examples, the device 10 may communicate data with the server 382. For example, the server 382 may store multimedia data that the device 10 receives and outputs to other output devices (e.g., displays and/or speakers). In some examples, the server 382 may store data output by the device 10. In such examples, the device 10 may intercept data from computers, displays, or other systems, and store that data.

The output device 384 may be any type of output device. For example, the output device 384 may be a screen, display, monitor, TV, projector system, other types of visual displays, speakers, other types of audio outputs, tactile outputs, or combinations thereof. For example, the device 10 may couple with a project using the output HDMI port 344 and the serial port 346. The output HDMI port 344 may communicate the multimedia data while the serial port 346 may communicate other instructions or commands to the projector system.

The device 10 may couple with other systems 386 such as, for example, an intercom system, a telephone system, an emergency response system, a security system, a building automation system, a climate control system, a lighting control system, an advertising system, or combinations thereof. The device 10 may be coupled to these devices using a variety of combinations of endpoints and/or ports.

The device 10 may also be configured to merge or combine different input streams from different sources into combined output streams. The device 10 may be generated output data streams using low-latency processing. In such a manner, time delays between different devices may be reduced.

As used herein, the term low-latency may refer to procedures or processes that take an amount of time that is either not perceptible to users or is perceptible to users, but is inconsequential to the task being undertaken. For example, a low-latency processor or other device may be configured to process a video data stream received from a computing device during a time frame such that a user cannot perceive (or the perceived delay is inconsequential) a difference between the video data stream output by a monitor at the computing device and a video data stream output by different output device connected to the device 10. In other examples, low-latency processing may refer to situations where two input data streams are merged with little to no perceived mismatch in timing of the two data streams.

In some examples, the device 10 may be configured to minimize a latency between content presented on the computing device 380 and content presented on an output device 384. In such examples, the computing device 380 may output a multimedia data stream (e.g., a video, an audio track, a power point presentation, etc.). The device 10 may receive the multimedia data stream (e.g., using the audio/visual endpoint 340) and output the multimedia data stream to the output device 384 (e.g., using the audio/visual endpoint 340). By using low-latency processing, a time delay between content output at the computing device 380 and content output at the output device 384 may be minimized. Other integration device may cause a delay to occur between the content source and the output device. Such a delay may impede multimedia presentations.

In some examples, the device 10 may be configured to minimize latency between content output by two different systems. In such examples, the computing device 380 may output a multimedia data stream (e.g., a video, an audio track, a power point presentation, etc.). The device 10 may split and output the multimedia data stream to two separate systems (e.g., a display and a separate speaker system). Differences in processing and transmission between these two systems may cause the audio to be offset from the video. Such a mismatch during a multimedia presentation may be undesirable. The device 10 may be configured to timestamp the multimedia data stream as it arrives and output the corresponding data streams to their respective systems based on the time states. In this manner, the device 10 may ensure that the audio and video data that is output match in their timing.

In some examples, the device 10 may be network with other integration devices 10 to provide a multi-location multimedia presentation. In multi-location presentations delays between different locations may be undesirable. For example, if the different locations are close to one another, a time delay in outputting content may cause a user in at a first location to hear an echo. For instance, if two classrooms are receiving the same presentation, the users in the classroom may hear the audio from both presentations, but the audio may be offset due to delays in processing. To address these time offsets, the device 10 may be configured to execute low-latency processing to minimize the time offsets. In some examples, the device 10 may time-stamp and buffer output data. The device 10 may output its own data with a delay in order to sync the presentations with other rooms. The device 10 may identify transmission delays associated with each of the connected other devices. In this manner, the time stamps on the output data may be used in conjunction with the identified transmission delays to sync multimedia presentations across multiple locations.

In some examples, the device 10 may be configured to combine data from different systems into a single output data stream. In some instances, the output data stream may be H.264 Advanced Video Coding or H.265 Advanced Video Coding. Sometimes different types of input data streams may be processed differently. Such differences in processing may take differing amounts of time. Such processing differences may cause a mismatch of content in a combined data stream. To avoid a mismatch, the device 10 may time stamp input data streams as they arrive. The device 10 may buffer those input data streams. The device 10 may merge the input data streams based on their time stamps. In this way, differences in processing for each input data stream may not create mismatch in the data in the resultant combined output data stream.

In some examples, the device 10 may be configured to receive data via Point-to-Point data sharing service, such as AirDrop. Upon receiving data via a Point-to-Point data sharing service, the device 10 may merge that data with other data and/or output that data to appropriate output devices as needed.

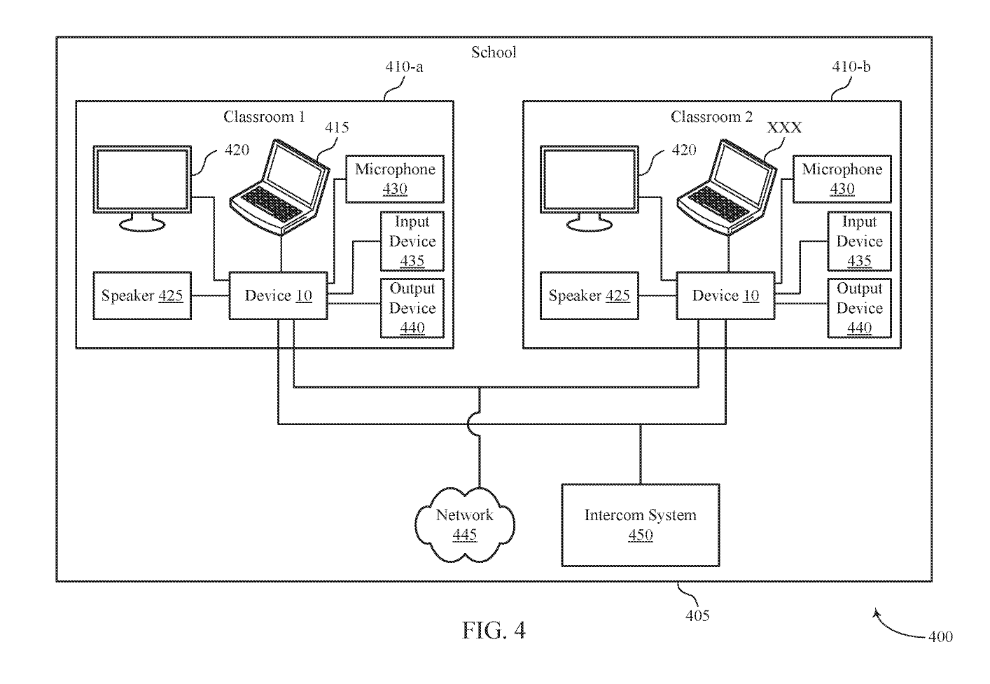

FIG. 4 is a block diagram 400 illustrating the integration device of FIG. 1 incorporated into a classroom setting. The block diagram 400 may include a school 405 with a plurality of classrooms 410. While two classrooms are shown, the school 405 may include any number of classrooms 410. The integration device 10 may be coupled to a number of different devices and systems in the school 405 generally and the classroom 410. For example, the integration device 10 may be coupled with a computing device 415, a visual output device 420 (e.g., monitor, TV, projector), an audio output device 425 (e.g., speakers), an audio input device 430 (e.g., microphone), an input device 435 (e.g., classroom call button or emergency button), an output device 440 (e.g., a light or a marquee), a communications network 445, an intercom system 450, or combinations thereof. The elements of the block diagram 400 may be similarly embodied as other similarly named elements described with reference to FIGS. 1-3.

The integration device 10 may address several challenges presented by educational settings. For example, the integration device 10 may provide a single device that is an endpoint for multiple school systems. In some cases, the integration device 10 may serve as both an intercom endpoint and an audio/visual endpoint. Because the device 10 is the endpoint for multiple systems, a number of different advantages may be realized. The device 10 may combine data from multiple sources. The device 10 may create local networks through which multi-classroom presentations may be communicated.

In some cases, the device 10 may be configured to interrupt computing device 415 and output devices 420, 425 based on receiving data from the intercom system 450. In some situations (e.g., emergency situations), the intercom system 450 may be used communicate vital information. The device 10 may be configured to interrupt other processes based on the receiving such messages. The intercom system 450 may comprise a plurality of intercom endpoints that are capable of communicating with one another. Intercom endpoints may be positioned throughout the school 405 in classrooms, offices, multi-purpose rooms and in other locations.

As already described, the device 10 may be configured to input and process audio visual data using low-latency processes to minimize time delays between the computing device 415 (e.g., content source) and the output devices (e.g., display 420, speakers 425).

The device 10 may be configured to merge different streams of input data. For example, a user (e.g., teacher or presenter) may present a video with both visual data and audio data. At various point through the video, the user may wish in to interject comments, but have those comments output through the speakers 425. To do this, the user may speak in the microphone 430. The device 10 may merge the audio/video data stream with the microphone data stream and output the respective data to the respective output devices. Some processors may take some time to process the audio data stream such that the sound produced by the speakers is heard after the sound spoken directly by the user. In such situations there is delay between the words spoken by the user directly and the amplified output of the speakers. Using low-latency processing, the device 10 may be configured to minimize such offsets.

The device 10 may be configured to merge data from different sources and record that data. For example, the device 10 may send a combined data stream to a storage device or a server.

The device 10 may be configured to perform multi-classroom presentations. For example, the device 10 in classroom 410-a may couple with the device 10 in classroom 410-b via the network 445. To avoid echoes between classrooms, the devices 10 may use any of the processing described with reference to FIG. 3. In some examples, the devices 10 may be configured to establish their own ad-hoc network directly between themselves. In some examples, the network 445 is a school-wide LAN or WLAN.

In some examples, the device 10 may be coupled with other input devices 435 and output devices 440. For example, some classrooms may have a call button and/or an emergency button. The device 10 may be configured to communicate information with such input devices 435. Some classrooms may also have a number of output devices such as indicators that may indicate when the call button has been pressed or emergency alarms (both visual and auditory). The device 10 may be configured to communicate information with such output devices 440. In some examples, the input devices 435 and the output devices 440 may be coupled with the device 10 via the multi-pin port, the serial port, the CAV port, the network endpoint, or combinations thereof.

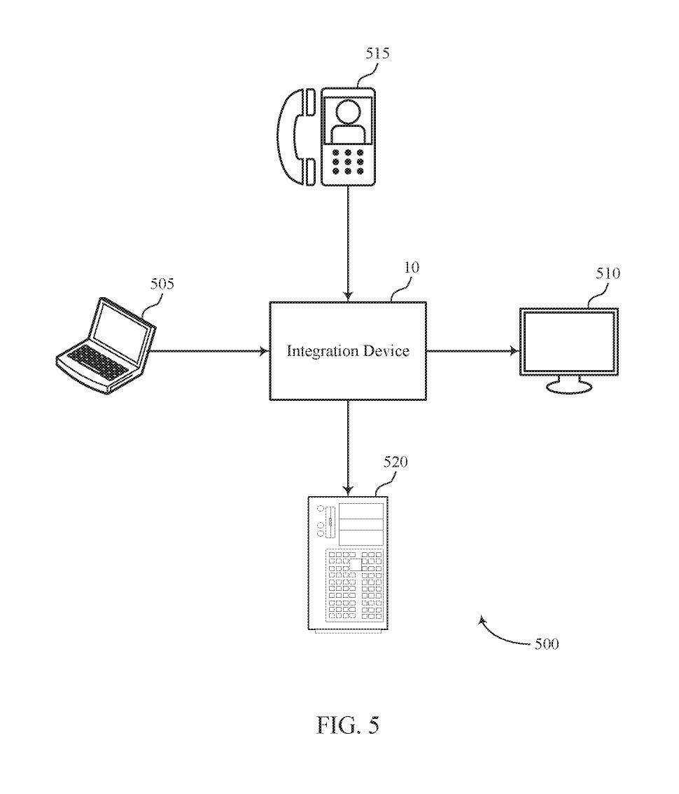

FIG. 5 is a block diagram 500 illustrating the integration device of FIG. 1 incorporated into a an emergency response setting. In emergency response settings, an emergency operator may receive telephone calls from individuals in need via an emergency telephone system. The emergency operator may use a computing system to identify information about the call and to input data received from the caller. In some situations, time and accuracy are critical.

Sometimes calls to emergency operators may be reviewed. For example, for training and quality control purposes, or because mistakes were made and negative consequences occurred. Because the computing systems and the telephone emergency systems may be two separate systems, there may be a mismatch between the telephone audio recording and the recording the computer data.

The device 10 may be configured to correlate and/or merge data streams of a computing device 505 that includes a monitor 510 and a telephone system 515. The resultant combined data stream may be transmitted to a server 520 or storage device to be stored for future review.

The integration device 10 may be positioned in line between the computing device 505 and an associated monitor 510. In this manner, the integration device 10 may intercept data being output via the monitor 510. The integration device 10 may make a copy of the intercepted data, allowing a first copy of the intercepted data to proceed to the monitor 510 and merging a second copy of the intercepted data with a telephone data stream.

The integration device 10 may also be positioned in line between the telephone system 515 and a user headset (not shown). In this manner, the integration device 10 may intercept data being output via the user headset. The integration device 10 may make a copy of the intercepted data, allowing a first copy of the intercepted data to proceed to the user headset and merging a second copy of the intercepted data with a visual data from the computing device 505.

The combined data stream that includes the computer visual data and the telephone data may be output to the server 520 for storage. In some examples, the integration device 10 may time-stamp the two input data streams before merging, and may merge the two data streams based on their time stamps. In this manner, the telephone data stream may be correlated with the computer data stream.

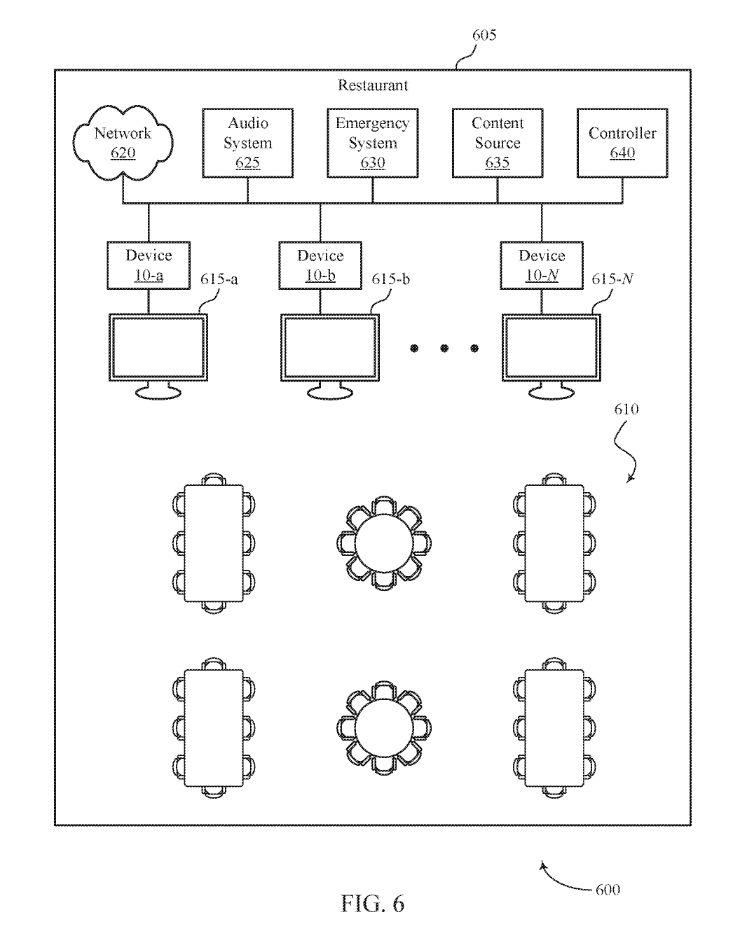

FIG. 6 is a block diagram illustrating the integration device of FIG. 1 incorporated into a public viewing setting. The public viewing setting may be at a restaurant 605 or sports bar, for example. While a restaurant is illustrated, the features described herein may apply to any location with multiple screens (e.g., a gym).

A restaurant 605 may include a seating area 610 with a plurality of displays 615 positioned around the seating area 610. The displays 615 may be showing any of a number of different programs such as different sporting events, game shows, new channels, movies, or other programming.

Devices 10 may be positioned in-line between the displays 615 and the other systems of the restaurant 605 including a network 620, an audio system 625, an emergency system 630, a content source 635, and/or a controller 640. The network 620 may be an example of a wired or wireless communications network. The audio system 625 may be an example of a speaker system installed at the restaurant 605. The emergency system 630 may be an example of a fire alert system, a security system, or other types of emergency response system. The content source 635 may be a computing device or a cable box(es). The controller 640 may be a computing device used by the restaurant 605 to control the displays 615.

The devices 10 may be configured to superimpose advertising data onto visual data output by the displays 615. The device 10 may receive a visual data stream from the content source 635 and advertising data (could be a stream or a file) from an advertisement source via the network 620. The advertising data may include advertisements associated with the establishment. The advertising data is different advertisements than what are already associated with the video data stream (e.g., advertisements sold by the network sponsoring the programming).

The devices 10 may be configured to present an output video stream that includes both the video data stream and the advertising data. For example, the device 10 may resize the video data stream and insert a scrolling banner advertisement at the bottom of the screen of the displays 615. In other examples, the device 10 may cause pop up advertisements to periodically appear on the screen of the display 615. The advertisements could be for various items sold by the restaurant 605 or for other entities, products, and/or services that purchased advertising rights from the restaurant 605. In other examples, the advertising data may be populated by an entity other than the restaurant 605 and other than the network sponsoring the programming.

The devices 10 may also be configured to manage what is being shown by the screens. The devices 10 may be configured to link an output of a display 615 to the audio system 625 so that visuals and audio of the program may be heard. In other examples, the devices 10 may be configured such that programming is interrupted when emergency messages are received from the emergency system 630.

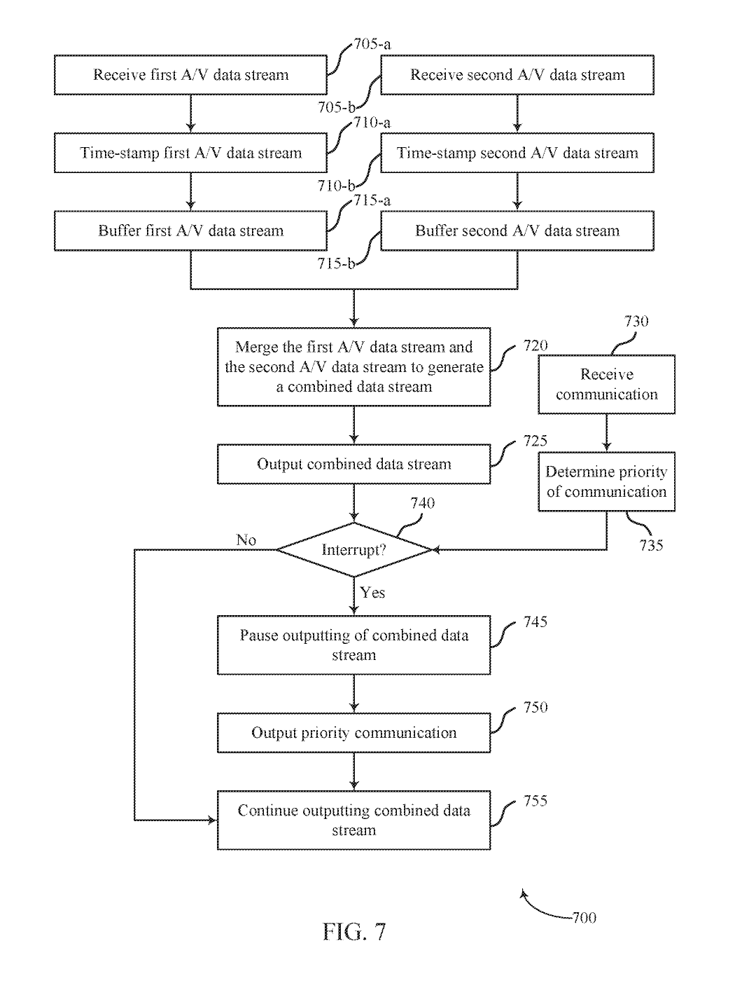

FIG. 7 shows a flowchart illustrating a method 700 in accordance with aspects of the present disclosure. The operations of the method 700 may be implemented by the integration device 10 or its components shown in FIGS. 1-3.

At blocks 705-a and 705-b, the integration device 10 may receive a first audio/visual data stream and a second audio visual data stream. These audio/visual data streams may be received simultaneously or concurrently. The first audio/visual data stream may be received using a first audio/visual endpoint of the integration device 10 and the second audio/visual data stream may be received using a second audio/visual endpoint different than the first audio/visual endpoint of the integration device 10.

At blocks 710-a and 710-b, the integration device 10 may time-stamp the first audio/visual data stream and/or the second audio visual data stream as the data streams are received. The integration device 10 may be configured to merge and correlate the two data streams to generate a single presentation. Different audio/visual data streams may take differing amounts of time to process. Such differences in processing may cause mismatches and offsets in a combined media presentation. By time-stamping the audio/visual data streams as they are received, the integration device 10 may be configured to identify a more precise timing alignment between the two data streams as compared to waiting until the data streams are fully processed.

At blocks 715-a and 715-b, the integration device 10 may buffer the time-stamped first audio/visual data stream and the time-stamped second audio/visual data stream. The integration device 10 may buffer the data streams to provide flexibility when merging the two data streams. In some cases, timing mismatches may arise between data streams based on different communication times, processing timelines, varying distances between sources, varying communication mediums, and so forth for the data streams. Buffering the data streams provide a larger window of opportunity correlate the timing of the two data streams when being merged into a combined data stream.

At block 720, the integration device 10 may merge the first audio/visual data stream and the second audio/visual data stream to generate a combined data stream. To merge, the integration 10 may correlate a timing of the first audio/visual data stream with a timing of the second audio/visual data stream. The integration device 10 may compare a time-stamp of the first audio/visual data stream with a time-stamp of the second audio/visual data stream. If the time-stamps satisfy a timing threshold, the integration device 10 may link the two portions of the data streams and combine those two linked portions into the same frame or unit of the combined data stream. If the time-stamps do not satisfy the timing threshold, the integration 10 may select one or more new time-stamps of the data streams and compare those time-stamps. In this manner, the integration device may correlate the two data streams into a single data stream.

Merging the data streams into a combined data stream in such manner may reduce mismatches, offsets, delays, or echoes that may occur in the combined presentation included in the combined data stream. For example, the integration device 10 may be used to merge video data with audio data received from a microphone. In this manner, a presenter (such as a teacher) may make comments about the video data and have that integrated directly into the data stream. Then the combined data stream may be stored or transmitted to other locations. In another example, two integration devices 10 may be used to present the same presentation in multiple locations but also allow to receive inputs (e.g., audio data) from both locations. In such examples, if the locations are close enough (e.g., two classrooms at the same school), mismatches in the output of the presentation may cause echoes and delays between the two locations thereby interfering with the presentation. The integration devices 10 may be configured to output the presentations in the two locations in a synchronized way to reduce interference caused by mismatches and propagation delays of the data. In another example, the integration device 10 may be used to merge telephone audio data with computer data. In some cases, an employer or other entity may want to record a conversation on a telephone and the content of a computer screen that are occurring simultaneously. For instance, at a 911 call center the actions of the operators may recorded for training purposes, quality purposes, or investigative purposes. In another example, the integration device 10 may be used to overlay visual data over a video feed. For instance, the integration device 10 may be configured to overlay advertisements of an establishment over a video stream such as a sporting event.

At block 725, the integration device 10 may output the combined data stream to one or more output devices. The output devices may include televisions, projectors, screens, speakers or other presentation tools. In some cases, the integration device 10 may coordinate the timing of its output with the timing of another integration device. By doing such coordination, interference due to echoes or other mismatches may improve the quality of the combined presentation. In some cases, the integration device 10 may buffer at least a portion of the combined presentation in order to better control the timing of the output of the combined data stream.

In some cases, at block 730, the integration device 10 may receive a communication over one of the two audio/visual data streams or over a third data stream or a different input. For example, the integration device 10 may include an intercom endpoint for an intercom system. While generating and outputting the combined data stream, the integration device 10 may receive intercom data or may receive some other type of data, such as an emergency message.

In some cases, at block 735, the integration device 10 may determine whether the received communication is a priority communication. To do this the integration device 10 may determine a priority level of the communication. The integration device 10 may compare the priority level to a priority level of other data streams being managed by the integration device 10. In some cases, certain types of communications may be given priority in a dynamic or semi-static fashion. In some cases, certain sources of information may be given priority. For example, the intercom system may be given priority over a microphone or a video presentation.

At block 740, the integration device 10 may determine whether the combined data stream should be interrupted by the received communication. In some cases, this determination may be done based on priority levels signaled in the communication itself, a type of the communication, a source of the communication, or a combination thereof.

At block 745, if the integration device 10 determines that the combined data stream should be interrupted, the integration device 10 may pause the outputting of the combined data stream. At block 750, the integration device 10 may output the priority communication. For example, upon receiving an intercom message, the integration device 10 may pause outputting of a video presentation automatically to reduce interference with the intercom message. In some cases, the integration device 10 may be configured to buffer the combined data stream or the first and second audio/visual streams while the combined data stream is paused. For example, sometimes the combined data stream may incorporate a live data feed and the audience does not want to miss any portion of the live presentation.

At block 755, the integration device 10 may continue outputting the combined data stream after the priority communication is complete. If the integration device 10 determines that the combined data should not be interrupted at block 740, the integration device 10 may jump directly to block 755 and not perform the operations of blocks 745 and 750.

The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

What is claimed is:

1. An integration device, comprising:
a first audio/visual endpoint coupled with a first content source, the first audio/visual endpoint configured to receive a first audio/visual data stream from the first content source;
a second audio/visual endpoint coupled with a second content source, the second audio/visual endpoint configured to receive a second audio/visual data stream from the second content source;
an integrator coupled with the first audio/visual endpoint and the second audio/visual endpoint, the integrator configured to merge the first audio/visual data stream and the second audio/visual data stream into a combined data stream; and
a third audio/visual endpoint coupled with the integrator, the third audio/visual endpoint configured to output the combined data stream to a remote output device.

2. The integration device of claim 1, wherein the integrator is configured to time-stamp the first audio/visual data stream as it is received and time-stamp the second audio/visual data stream as it is received, and the integrator is configured to correlate a timing of the first audio/visual data stream and a timing of the second audio/visual data stream based at least in part on the time-stamping the first audio/visual data stream and the second audio/visual data stream.

3. The integration device of claim 1, wherein the first audio/visual data stream comprises audio data and the second audio/visual data stream comprises visual data.

4. The integration device of claim 3, wherein the first content source comprises a microphone configured to output a signal representative of a human voice, wherein the integrator is configured to merge the audio data with the visual data to generate a synchronized multimedia presentation.

5. The integration device of claim 3, wherein the first content source comprises a telephone, wherein the integrator is configured to merge the audio data with the visual data to generate a synchronized recording of the audio data and the visual data.

6. The integration device of claim 5, wherein:
the telephone is part of an emergency calling system configured to receive emergency calls; and
the second content source a visual output of a computer, wherein the integrator is configured to mitigate a mismatch between the audio data of the telephone and the visual output of the computer.

7. The integration device of claim 1, wherein the first audio/visual data stream comprises first visual data and the second audio/visual data stream comprises second visual data.

8. The integration device of claim 7, wherein the integrator is configured to overlay the first visual data over the second visual data, wherein the first visual data is an advertisement and the second visual data is television data.

9. The integration device of claim 1, wherein the first audio/visual endpoint is an intercom endpoint coupled with a local intercom system, the intercom endpoint configured to receive an audio data stream from a remote intercom endpoint of the local intercom system different than the intercom endpoint.

10. The integration device of claim 1, further comprising:
an infrared receiver configured to detect signals using an infrared frequency spectrum band.

11. The integration device of claim 1, further comprising:
an ultrasonic transceiver configured to generate or detect signals using an ultrasonic frequency spectrum band.

12. The integration device of claim 1, further comprising:
a component audio video (CAV) port configured to be coupled with an electronic marquee sign, wherein the integrator is configured to generate an output for the electronic marquee sign based at least in part on the first audio/visual data stream or the second audio/visual data stream.

13. A system, comprising:
a first integration device in a first room of a building, the first integration device including a first audio/visual endpoint configured to receive a first audio/visual data stream and a second audio/visual endpoint configured to receive a second audio/visual data stream, the first integration device configured to merge the first audio/visual data stream and the second audio/visual data stream to form a third audio/visual data stream
a second integration device in a second room of the building, the second integration device coupled with the first integration device via a communication link and configured to receive the third audio/visual data stream from the first integration device, the second integration device including a third audio/visual endpoint configured to receive a fourth audio/visual data stream from a content source, the second integration configured to merge the third audio/visual data stream received from the first integration device and the fourth audio/visual data stream to form a fifth audio/visual data stream, and wherein the second integration device is configured to transmit the fifth audio/visual data stream to the first integration device.

14. The system of claim 13, wherein the first integration device outputs the fifth audio/visual data stream to a first output device and the second integration device outputs the fifth audio/visual data stream to a second output device simultaneously to reduce offsets in a presentation of audio/visual content between the first room and the second room.

15. The system of claim 14, wherein the first integration device and the second integration device are configured to time-stamp audio/visual data streams as the audio/visual data streams are received, wherein merging two different audio/visual data streams and outputting the audio/visual data streams are based at least in part on the time-stamping.

16. A method, comprising:
receiving a first audio/visual data stream from a first content source;
time-stamping the first audio/visual data stream as it is received;
buffering the time-stamped first audio/visual data stream;
receiving a second audio/visual data stream from a second content source;
time-stamping the second audio/visual data stream as it is received;
buffering the time-stamped second audio/visual data stream;
merging the buffered first audio/visual data stream and the buffered second audio/visual data stream based at least in part on the time-stamping to form a combined data stream; and
outputting the combined data stream to a remote output device.

17. The method of claim 16, further comprising:
correlating a timing of the first audio/visual data stream with a timing of the second audio/visual data stream based at least in part on the time-stamping, wherein merging the buffered first audio/visual data stream and the buffered second audio/visual data stream is based at least in part on correlating the timings.

18. The method of claim 16, further comprising:
determining a priority of a communication in the first audio/visual data stream; and
interrupting the second audio/visual data stream to output the first audio/visual data stream based at least in part on determining the priority of the communication.

19. The method of claim 16, further comprising:
overlaying a visual portion of the first audio/visual data stream over a visual portion of the second audio/visual data stream to generate a composite image.

20. The method of claim 16, further comprising:
transmitting the combined data stream to the first content source based at least in part on the first content source being an integration device, wherein the first content source is configured to output the combined data stream to a second output device different than the remote output device; and
outputting the combined data stream at the same time with the first content source outputs the combined data stream based at least in part on transmitting the combined data stream to the first content source.
